(19) United States
(12) Patent Application Publication
(10) Pub. No.: US 2024/0420240 A1
(43) Pub. Date: Dec. 19, 2024

(54) Rolling Feedback System For Financial And Risk Analysis Using Disparate Data Sources

(71) Applicant: FP Alpha, Inc., New York, NY (US)

(72) Inventors: Andrew ALTFEST, New York, NY (US); Luis QUIROZ, Mexico City (MX)

(73) Assignee: FP Alpha, Inc., New York, NY (US)

(21) Appl. No.: 18/816,833

(22) Filed: Aug. 27, 2024

Related U.S. Application Data
(63) Continuation-in-part of application No. 17/027,458, filed on Sep. 21, 2020, now abandoned.
(60) Provisional application No. 62/902,897, filed on Sep. 19, 2019.

(51) Int. Cl. G06Q 40/06; G06V 30/41

(52) U.S. Cl. CPC G06Q 40/06; G06V 30/41

(57) ABSTRACT

This a computerized rolling feedback system for financial and risk analysis comprising a database of recommendation information representing financial risk information of a set for past participants; a set of financial situational information for a target participant taken from the group consisting of mortgage, financial or debt statement, loan document, tax return, insurance policy, will, trust, a financial plan and a debt-to-income ratio analysis; a computer system adapted to receive an additional information, determine an information type according to a similarity engine included in the computer system using a similarity analysis and modifying the financial risk information according to the additional information, apply a digital ruleset stored on the computer system to provide a recommendation for financial risk information modifications according to a comparison of the financial risk information with the financial situational information.

### BACKGROUND OF THE SYSTEM

### 1) Field of the System

A system for using rolling feedback and natural language processing to extract information from disparate sources for providing predictive analysis used to suggest courses of action in financial planning.

### 2) Description of the Related Art

In today's economy, the ability to manage cash is a crucial step in the short- and long-term wellbeing of your financial future. Without a comprehensive financial plan, individuals can find themselves living paycheck to paycheck, having insufficient funds to manage unexpected events (e.g., job loss, home or vehicle repair, medical bills, etc.) or not meeting their personal or professional financial goals. Not having sufficient funds to provide for families, plan, and enjoy leisure time which can limit choices and create emotional distress that can lead to depression, low self-esteem, and impaired cognitive functioning. When individuals turn to debt to mask problems with financial planning, problems can be magnified. Having and implementing a financial plan can remove or reduce these risks, financially and emotionally.

Due to their nature, financial plans tend to be customized for each individual, as no two individual's circumstances are exactly alike. Further, financial plans should consider more than just investments and savings and can benefit when they include housing costs and future plans, debt payment (and debt satisfaction), taxes, risk management (e.g., insurance), retirement contributions, general savings, and daily financial needs.

Traditionally, the task of compiling and analyzing this information has been a labor-intensive process requiring the manual review of mortgage documents, bank statements, debt statements, loan documents, tax returns, retirement statements, insurance policies, ratio analysis and other factors. This process does not produce a comprehensive plan that can be useful to customer as it relies on the “artform” rather than an objective analytical automated system. Further, the transitional process can be expensive and limited to the documents of the target individual without consideration of other data sources. Traditionally, this process is typically performed by a financial advisory that relies upon experience learned from each financial plan developed by the advisor. It has been noted that financial advisors who have advanced professional designations and more years of experience, tend to command higher financial planning fees in the marketplace which suggests that the market recognizes varying levels of competence and value, however, this market result could also mean that these advisors are better at marketing their greater credentials and experience than others.

There have been some attempts to automate financial planning, but none provide for the data gathering and rolling feedback of the present system. Further, none include the comprehensive integration of disparate data sources. Further, traditional attempts to automate financial planning are limited in their consideration of the holistic circumstances of the target individual. For example, U.S. Pat. No. 7,536,332 is directed to an implementation of rebalancing an investor's security portfolio based on the specified investment parameters. The method utilizes a conventional mean-variance efficient portfolio frontier analysis, which is often cited in Modern Portfolio Theory (MPT), one of the major scholarly developments in modern finance, finds its way into actually rebalancing the investor's security portfolio. U.S. Pat. No. 6,253,192 is directed to a method of financial planning in which a financial model is created from data relating to a subject's income, expenses, assets, and liabilities. A planning rules database is created from data relating to a preferred financial strategy. This reference is limited to the specific data sources of the subject's income, expenses, assets, and liabilities and does not include sufficient data sources to provide for a comprehensive plan.

U.S. Pat. No. 6,012,043 is a computer implemented tool used primarily in financial planning which produces estimated values of needed savings levels and further income based on certain economic assumptions and data regarding an individual subject's current financial status. The disclosed tool uses decision logic and user preferences to provide output presented in a graphical format. U.S. Pat. No. 5,819,263 is directed to a system for providing proactive service to targets with the disclosed group management system. The system is a work management tool that organizes an advisor's day-to-day operations, workflow, targets, and prospects.

None of these prior attempts include the ability to gather data from disparate data sources, provide for a rolling feedback function and provide for the ability to learn from each target and analyze previous targets and plans for potential updated recommendations.

Therefore, it is an object of the present system to provide for a computerized system that can gather data from disparate data sources for use in the financial planning process.

It is also an object of the present invention to use natural language processing techniques to gather data from disparate data sources for use in the financial planning process.

It is also an object of the present invention to use rolling feedback from prior financial planning projects to provide predictive analysis used to offering courses of action in financial planning.

It is also an object of the present invention to use prospecting functionality to predict potential changes in recommendation to a financial plan based upon input that includes changes in the data of the target and data from new targets.

### BRIEF SUMMARY OF THE SYSTEM

The above objectives are accomplished by providing a computerized rolling feedback system for financial and risk analysis using disparate data sources comprising: a database of recommendation information representing financial risk information of a set for past participants; a set of financial situational information for a target participant taken from an information set taken from the group consisting of a mortgage document, a bank statement, a debt statement, a loan document, a tax return, a retirement statement, an insurance policy, a will, a trust, a financial plan and a debt-to-income ratio analysis; a computer system adapted to receive an additional information, determine an information type according to a similarity engine included in the computer system using a similarity analysis and modifying the financial risk information according to the additional information, apply a digital ruleset stored on the computer system to provide a recommendation for financial risk information modifications according to a comparison of the financial risk information with the financial situational information.

In one embodiment, the computer system is adapted to create an initial financial plan according to the comparison of the financial risk information with the financial situational information, which may include personal financial goals of the target participant.

In one embodiment, the digital ruleset is a learning model created using multiple individual experts in the fields of tax, insurance, accounting, personal finance, wealth management, and estate planning.

In one embodiment, the computer system is configured to digitally transmit the recommendation to a remote advisor computer system inaccessible to the target participant. The computer system may also be configured to receive a recommendation compliance representing that a recommendation was accepted and modify the database of recommendation information according to the recommendation compliance. In one embodiment, the database of recommendation information is a first database of recommendation information, and the computer system is configured to digitally modify a second database of recommendation information stored on a remote computer system according to the recommendation compliance.

In one embodiment, the database of recommendation information is created using a natural language engine having natural language computer readable instructions, receiving natural language, generating a translation model using context, reading natural language derived data from the natural language according to a translation model, and modifying the database of recommendation information.

In one embodiment the computer system is adapted to pull additional information from a third-party electronic source, which is taken from a financial computer system, a credit computer system, an investment computer system, a mortgage computer system, a student loan computer system, and a home insurance computer system.

In one embodiment, the computer system further comprises a similarity engine having similarity computer readable instructions for comparing the financial situational information of a target participant with additional information associated with the target participant and determining if a difference between the target input and the existing input is sufficiently similar to determine that the target input and the existing input are of a same data type.

### BRIEF DESCRIPTION OF THE SEVERAL VIEWS OF THE DRAWINGS

The construction designed to carry out the system will hereinafter be described, together with other features thereof. The system will be more readily understood from a reading of the following specification and by reference to the accompanying drawings forming a part thereof, wherein an example of the system is shown and wherein:

FIG. 1 is a schematic of various aspects of the system;

FIG. 2A is a schematic of various aspects of the system;

FIG. 2B is a schematic of various aspects of the system;

FIG. 3A is a flowchart of aspects of the system;

FIG. 3B is a flowchart of aspects of the system;

FIGS. 4A through 4F are images representing the display provided to a user and the underlying computer readable instructions of the system;

### DETAILED DESCRIPTION OF THE SYSTEM

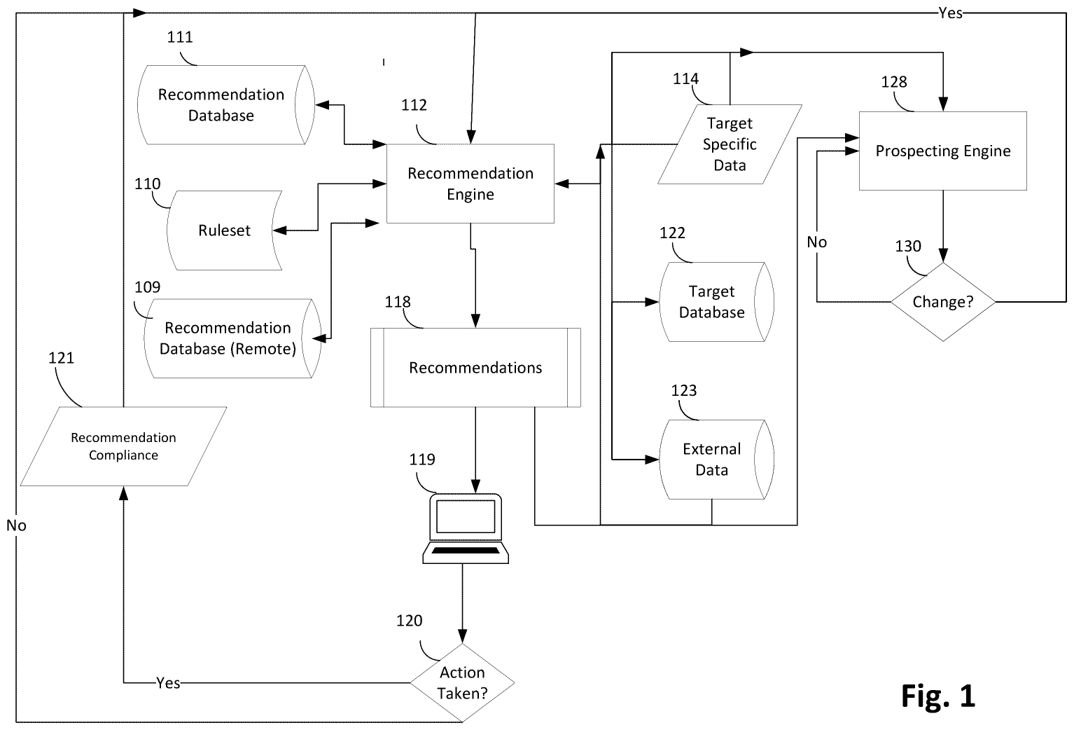

With reference to the drawings, the system will now be described in more detail. Referring to FIG. 1, the system can include a digital ruleset 110. The ruleset can be an initial ruleset that can be generated from information taken from a relevant industry including professionals and experts in the industry or a modified ruleset as described herein. Given that this system is comprehensive system that includes disparate data sources, the ruleset can include sub-rulesets that can each represent an area of an industry or subject matter that can be aggregated for a comprehensive output. For example, when providing recommendations to a professional advisor and/or a remote advisor computer system that is inaccessible to the target, the system can use a ruleset that includes sub-rulesets taken from subject matter groups typically considered by financial planners and/or when creating an financial, investment, estate and/or retirement plan, including but not limited to tax obligations and planning, insurance coverage (including disability, auto, medical, home, life, and others), existing and anticipated debt (including mortgage, student loans, auto, unsecured debt and the like), identify theft risk analysis and prevention, life and the like), long term care planning, estate planning (including wills and trusts) and the like. For example, a consultant in the retirement planning/estate planning fields can be the source of the initial ruleset with rules directed to revocable trusts, how assets should be titled in the trust to comply with the purposes of the trust and the goals and interests of the various parties to the trust. These rulesets can be digitally stored in the system and used as an initial dataset for the recommendation engine 112.

After the initial ruleset is developed, the recommendation engine can update the ruleset according to information that is learned from using the ruleset to develop financial plans for targets according to the target's financial goals, financial situational information that is included in the target specific data 114, the recommendation information contained in the recommendation database 111 and the digital ruleset 110 used to compare the target financial situational information to contained in the recommendation information. When the target specific information 114 is gathered, recommendations 118, which represent financial risk information for past targets, are selected from the recommendation database 111 and/or provided according to a comparison of the target's financial goals, and a comparison of the target specific information 114, which includes the financial situational information with the financial risk information. Those recommendations are digitally transmitted by the system to a remote advisor computer system 119, which is operated by the financial advisor but is not accessible by the target. Upon receiving the recommendation and/or financial plan, the financial advisor may modify the recommendation and/or financial plan prior to the recommendation and/or plan being provided to the target and the ruleset may be updated to reflect such modifications. The target's action 121 in response to the recommendations (e.g., whether the recommendation was followed, modified, or ignored) can be recorded and the ruleset updated to reflect the target's actions and/or modifications. For example, the initial ruleset may state that once the target reaches a pre-determined age, then investments should be moved from stocks to cash. When subsequent targets are presented with this recommendation at the predetermined age, but the financial planner or the target elect to use a second pre-determined age, the ruleset can be updated to reflect the second pre-determined age so that future recommendations use the second pre-determined age. Therefore, this system can provide for continuous feedback from subsequent events, data and actions taken so that the recommendation engine can continue to provide updated information to the recommendation engine.

When target specific data 114 is entered for a particular target, it can be processed by the recommendation engine, wherein the digital ruleset 110 is used to compare the target's financial situational information 114 to the recommendation information stored in the recommendation database 111 and based upon the results of the recommendation engine and the ruleset, the recommendation engine may provide for recommendations 118 for that target that were initially selected from the recommendation database 111, which may reside in or be in communications with the recommendation engine 112. The target specific data 114 may include financial situational information for the target and may be taken from the group consisting of a mortgage document, a bank statement, a debt statement, a loan document, a tax return, a retirement statement, an insurance policy, a will, a trust, a financial plan, and a debt-to-income ratio analysis.

From time to time, the system may receive additional data that may be used to select a recommendation 118 to be provided and/or to modify the rule set 110 used to select the initial recommendation. The additional data may be in the form of additional financial situational information 114 that may be entered by the target and/or financial professional in any of the methods discussed herein (e.g. a new tax return, a new income statement, a new loan document, etc.) or the additional information may comprise external data 123 and may relate to the market (e.g., interest rates, inflation, mortgage rates, changes in the law, etc.). This additional data may be retrieved by the system automatically or it may be input by the financial planner and/or target in the manners discussed herein.

The target can have attributes that can include the target specific data, including the financial situations information, as well as other attributes such as demographics, marital status, family, requirement goals, retirement age, geographic location, vacation preferences, hobbies, risk tolerance, assets, health, insurance coverage, occupation, work status, college planning, finances (e.g., expenses, debt, income), estate planning, and the like.

The recommendations can be presented on a user interface that can be used by the financial planner to present options to the target. The recommendations can also be presented in report format and delivered to the target. The report format can be formatted with technical information for the financial planner or formatted for readability for presentation to the target.

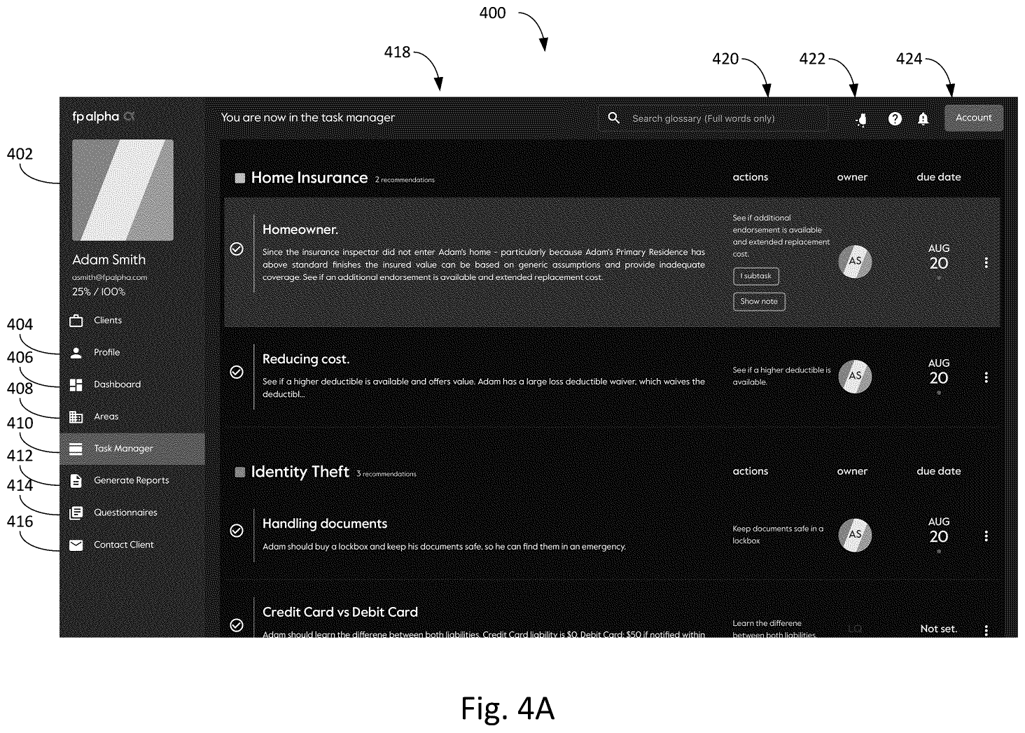

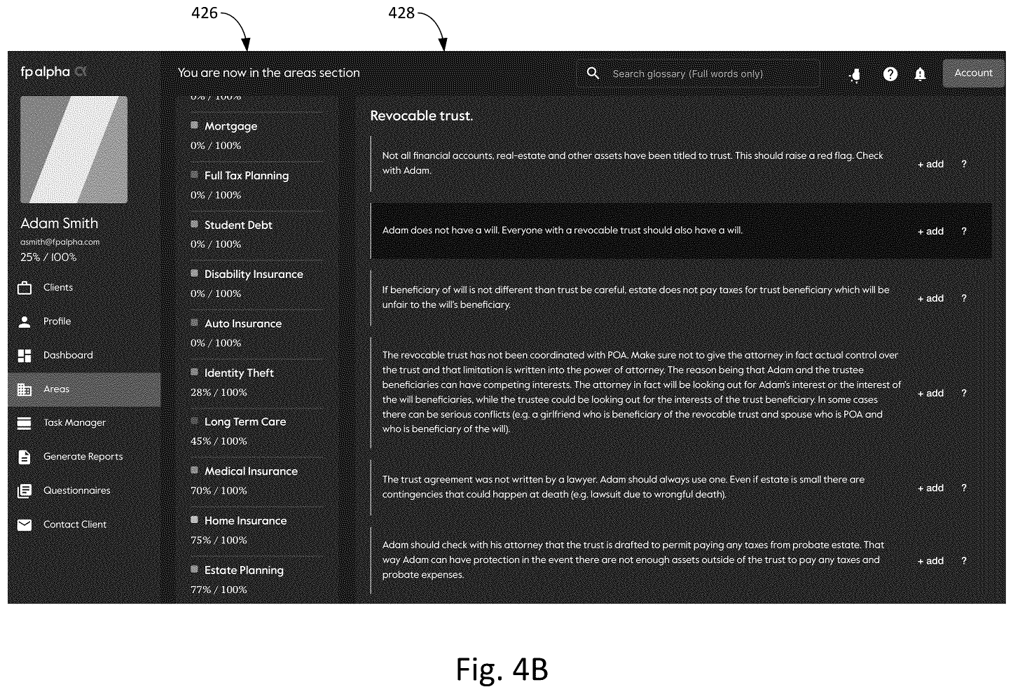

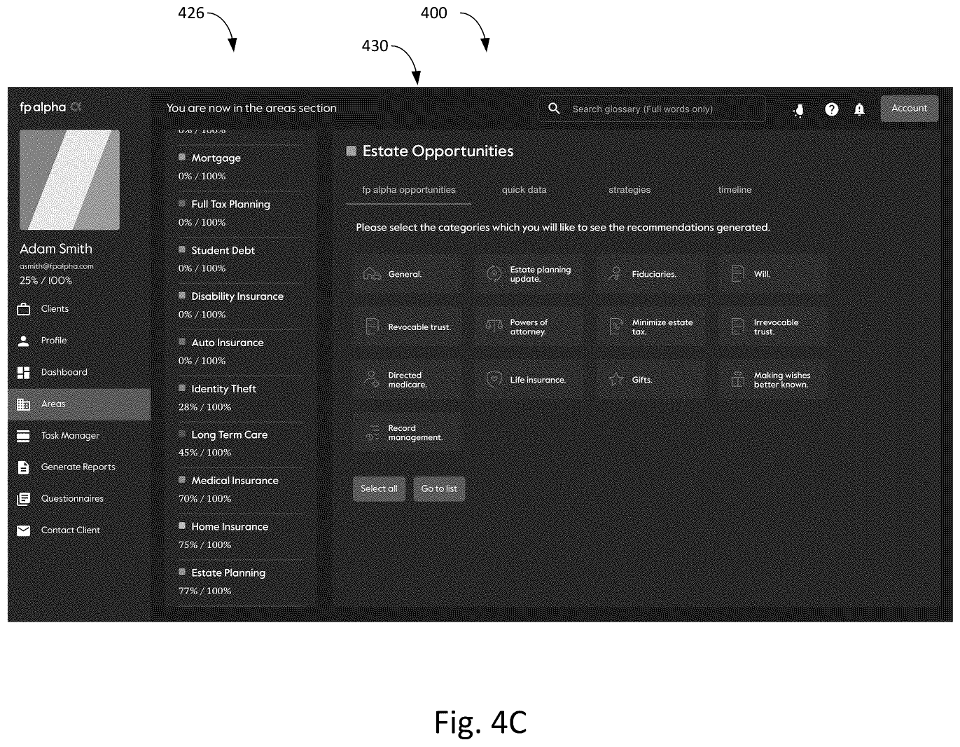

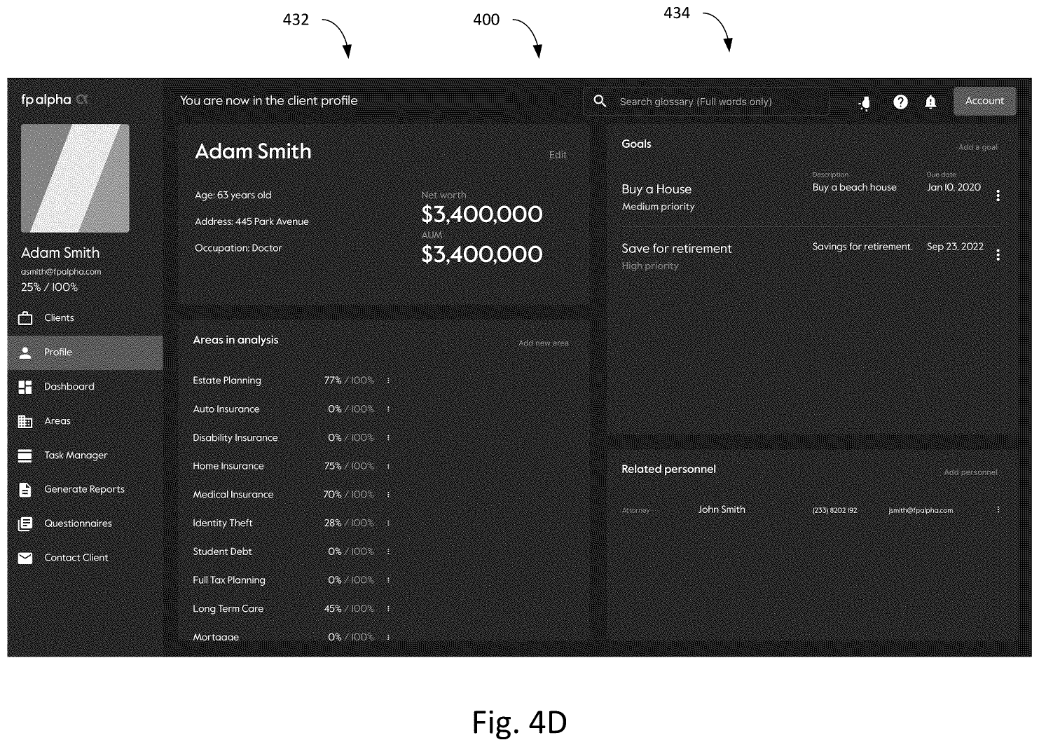

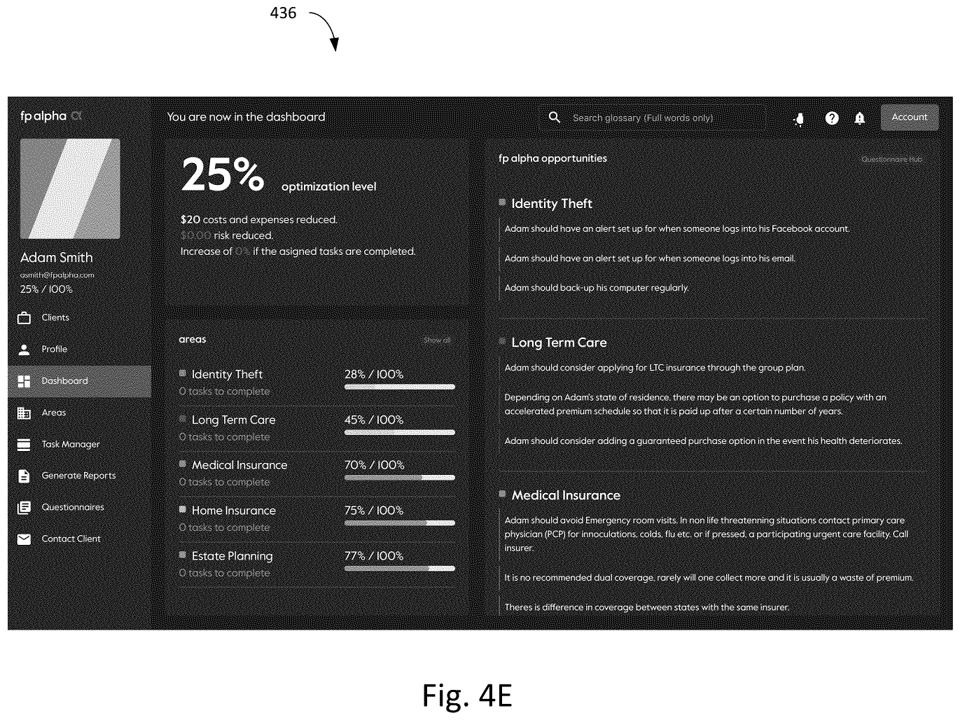

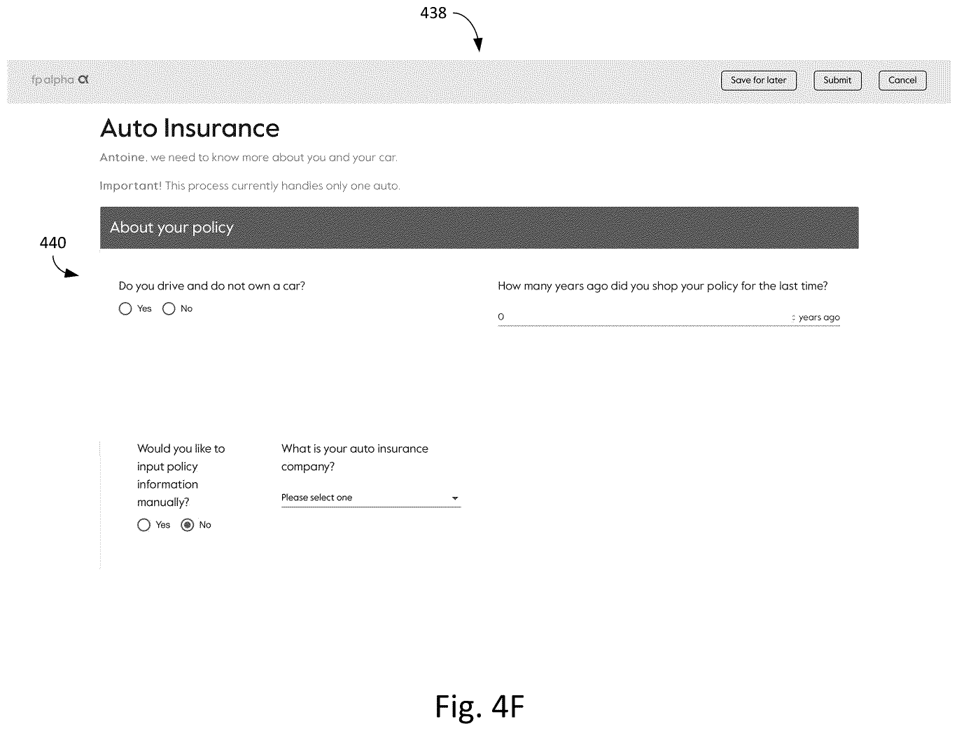

When the recommendations are selected and/or provided, the user can be alerted as to actions to take. These actions can include deadlines associated with the recommendation as shown in FIG. 4A. The user can subsequently determine at 120 if and what action was taken associated with the recommendation. If action was taken, the recommendation compliance information, representing what action or inaction was taken by the target in response to the recommendation, can be recorded at 121 and provided to the recommendation engine. The recommendation engine can then use the recommendation compliance information 121 and update the digital ruleset accordingly. In one embodiment, the recommendation engine can store in a second recommendation database 109 the recommendations modified according to the recommendation compliance information. The second recommendation database 109 could be stored on a remote computer system and in one case, the second recommendation database could be stored on the advisor computer system 119. In another embodiment, the system, upon receiving the recommendation compliance information 121 may access the second recommendation database 109 and modify the recommendations stored therein according to the recommendation compliance information so that future recommendations 118 are selected from the second recommendation database 109. The recommendation engine can also draw information from external data sources 123 such as tax rates, interest rates, inflation rates, educational costs (actual and averaged), life span, housing costs, cost of living (including per geographic area), and other information that can affect the future of the target.

The system can include a prospecting engine 128. The prospecting engine can monitor several data sources including target specific data inputted into the system, the target database, external data, and other information sources for changes. When a change is detected, the prospecting engine can actuate the recommendation engine to determine the effect of the change on the target. For example, if the cost-of-living increases for the geographic region that the target is living, the recommendation engine can provide new or modified recommendations and present these to the financial professional for review and subsequent presentation to the target. The recommendation engine can continuously monitor a target or potential target's information such as the target's financial information, age, family information, or other changes. If there is a change detected at 130 it can be determined if the change exceeds a predetermined threshold or event. If so, the prospecting engine can actuate the recommendation engine and provide the recommendation engine with the changes. In one embodiment, the recommendation engine can receive the actuation from the prospecting engine and generate recommendations from information retrieved by the recommendation engine.

For example, if the prospecting engine determines that a target's children have reached college age and can make recommendations accordingly based upon the target's college financial needs. The prospecting engine can determine that the cost of living in a certain geographic area has changed, determine the targets in the target database that are within the geographical area and actuate the recommendation engine for those affected targets. The prospecting engine can determine that interest rates have changed for certain loans and actuate the recommendation engine for those targets that may be affected by the interest rate change.

The prospecting engine can also detect when a recommendation is made for a first target, determine if there is an existing target with similar attributes for the subject associated with the recommendation, and actuate the recommendation engine to determine if new or modified recommendation, action or inaction should be provided to an existing target in the target database. The prospecting engine can review the target database for existing targets and provide new or modified recommendations based on a new target entered into the system. Once actuated, the recommendation engine can provide new or modified recommendations according to the change detected by the prospecting engine. This allows the system to provide for feedback on a rolling basis when a new target is entered into the system or other changes occur so that existing targets can benefit from subsequent actions or inactions according to recommendations based upon similar attributes.

In another embodiment, the prospecting engine 128 can receive target specific data 114, including target attributes and/or financial situational information regarding or otherwise associated with a potential target. This information may be entered manually by the potential target or by any other manual or automated method discussed herein. Upon receiving such target specific data, the prospecting engine can determine if there is an existing target with similar attributes and/or financial situational information and if an existing target with sufficiently similar attributes exists, the prospecting engine may provide to the potential target with one or more recommendations provided to the existing target. Thus, the system allows for the system may be used to market financial services to potential targets without the need to meet with the potential target and/or collect target specific data from the potential target.

The process of receiving change information from disparate sources (e.g., new targets, potential targets, third parties, temporal changes, and the like), making recommendations, taking action, electing not to take action, updating target information in the target database and provides for a feedback loop that can further enhance the ability of the recommendation system to provide recommendations for a target. The specific target data can be updated with these changes and recommendations can be provided according to the change. For example, if the target reaches a certain age, recommendations concerning subject matter such as Medicare can be triggered and provided to the financial planner for use in providing services to a target.

In one embodiment, the computerized system can include an input engine which receives information such as scanned forms, directly entered input, input from third party sources and the like. The information can be in physical or digital format. If the input is not in a digitally acceptable format, the input engine can create a digital input representation of the input which can be a binary format of the input. The input can take the form of a mortgage document, a bank statement, a debt statement, a loan document, a tax return, a retirement statement, an insurance policy, a will, a trust, a financial plan, a debt-to-income ratio analysis and any combination thereof. The input can be a physical form or can be a digital form.

When the input is received, the input needs to be categorized so that the relevant field can be extracted. This system does not require that the user identify the input as the system automatically improves the function of a computer system and uses a similarity engine to determine the field to extract. The digital input representation can be associated with a document type using various identification means such as vector analysis discussed below. The similarity engine can determine which information (e.g., fields) to extract and export from the digital input representation that can be in a binary format for machine readability. Note that the binary information is not human readable.

For example, if a loan document is inputted, the system can determine the similar of the input to existing loan documents that are in a database or that have been previously entered and identified as a loan document. The system can then extract fields from the loan document that are consistent with the information type—such fi4ld including principal, interest, payments, balance, and the like. Therefore, the digital input representation can be determined from the document without the user having to identify the document input.

After information has been extracted, the system can make recommendations using a recommendation engine. For example, input can include insurance information. The loan information can indicate that real property is in the possession of a target for analysis. The loan can provide the value of the real property and therefore the recommended insurance amount (e.g., 100% of the value) so that in the event of a loss, insurance is sufficient to cover the loss. If the input includes insurance information that is not sufficient, the system can recommend that the insurance coverage be increased and provide a recommended amount.

A ruleset can be used to assist with the recommendations, in that it can include rules that are to be followed for recommendations. For example, the rules can sta5te that the insurance amount for a real property of a certain type and value should be XXX % of the value of the property according to loan information. The recommendation engine can also receive information that a specific recommendation was implemented (e.g., review, accepted and implemented) so that the recommendation engine know that a recommendation was accepted and acted upon. The recommendation engine can then determine that a certain recommendation was widely accepted, narrowly accepted, or rejected. Based upon the status of the received recommendation information, the recommendation engine can update the database of recommendations accordingly. For example, if the recommendation is that the insurance should be 110% of the real estate value according to a loan, and the recommendation is rejected so that only 90% of the value is insured, the recommendation engine can update the recommendation database and ruleset of that 90% is the next recommendation for that property type and value, This provides machine learning and allows the implementation acceptance and rejection of recommendation to teach the system recommendations that are more acceptable and those that are not. For example, if the recommendation that 110% of the value of real property should be insured and this value is always rejected, the database and ruleset can be modified to remove the 110% value recommendation. T

The ruleset can include information that is related to tax, insurance, accounting, personal finance, wealth management, estate planning and any combination thereof.

Once recommendations are accepted, an initial action plan can be created which is an implementation plan for the recommendations. The action plan can be created according to the recommendations and the personal financial goals of a target participate so that the action plan can be tailored to each participant according to the digital input representation and the recommendations. The recommendations and the action plan can be transmitted to a third party. For example, the advisor can receive the action plan and the recommendations. The advisor can use a remote computer system that is not accessible to the participate so that the advisor can provide insight into the plan, accept, or reject recommendations, modify the plan of otherwise provide insight prior to presentation to the participant. By allowing access only to the advisor, the recommendations can be reviewed prior to implementation and even the creation of an action plan.

In one embodiment, the system can receive information representing the compliance with the recommendation from the participant. It can be determined if the participant properly implemented the recommendations and the action plan. Input can be received from the participant that shows the actions taken or not taken by the participant. For example, insurance information can be received which allows the system to determine if the actual insurance policy is consistent with the recommendations. The system can revise the recommendations accordingly and provide updated recommendations to the advisor and the participant.

In one embodiment, the computerized system can transmit the database of recommendations, and the rules set to a second computerized system. Therefore, the second system can benefit from the recommendations database modifications that occur according to the first system. This allows the second system to learn from the first system benefit the second advisor and participant.

The input and recommendations can be created using natural language that can receive the natural language as input and provide a translation into the digital input representation. For example, the input can include a contract that has natural language. The system can retrieve the language and translate it into the digital representation by determining the document type and the fields for extraction. For example, the system can determine that the natural language us most closely associated with a loan document and therefore extract fields from the loan such as principal, interest rate, balance, and the like.

The system can also retrieve information from third party sources. For example, downloaded banking information, asset information and the like. For example, if input is determined to be a real estate loan, the system can access third party property records and retrieve additional information about the real property. Using this information, the system can create recommendations that are tailored to the specific real property. For example, the third-party information may indicate that the real property is in a flood zone and make the recommendation that the insurance include flood damage. This can be done without the need for human interaction so that a more thorough review and accurately are improved over the current state of the art.

In one embodiment, the display of the recommendations can be in the form of a dashboard that can be easily seen.

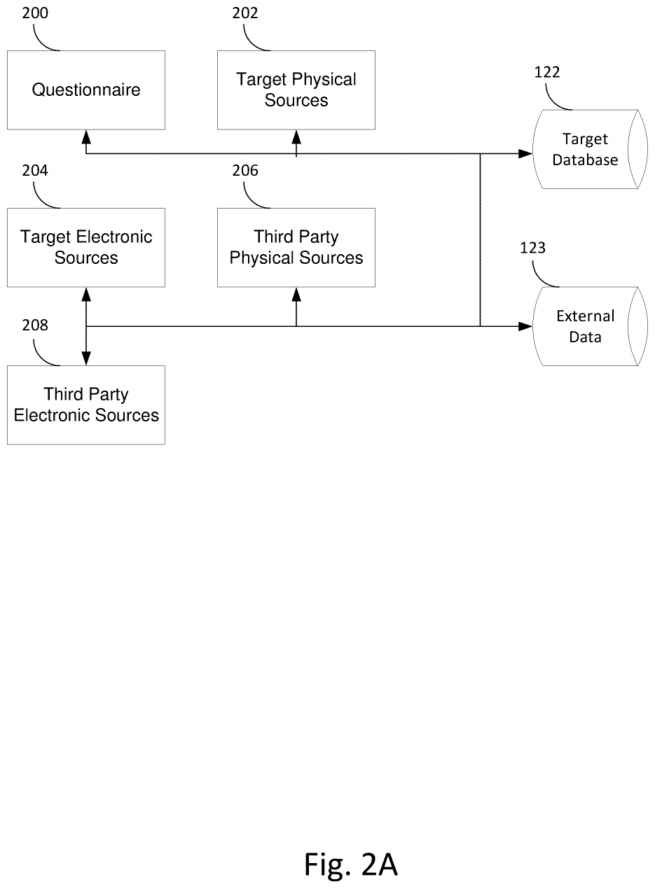

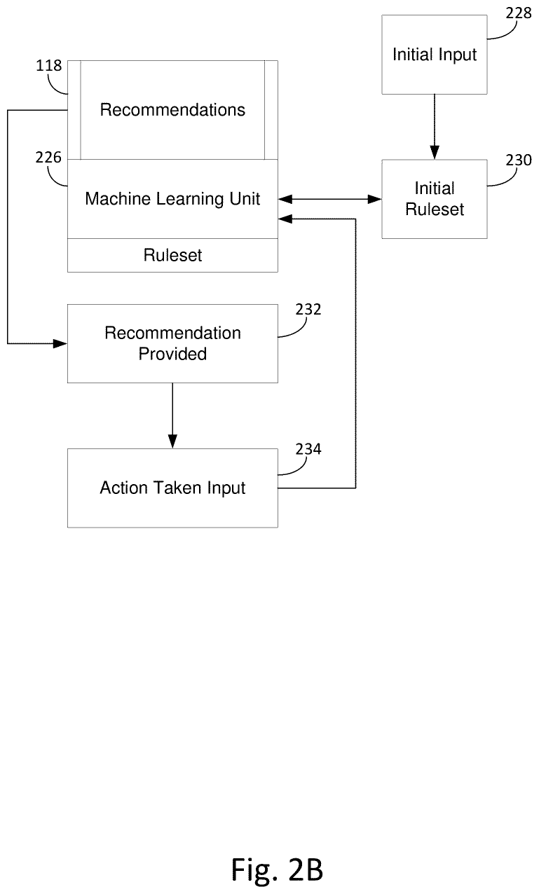

Referring to FIG. 2A, information and data can be retrieved or received from multiple sources including input in response to data requests such as a questionnaire (e.g., written survey or oral interview) response 200. The input from the questionnaire can be associated with the target and stored in the target database. Data and information can also be retrieved from physical sources 202 provided by the target including physical material such as tax returns, insurance policies, wills, trusts, bank statements, credit and loan statements, contracts, and the like. Data sources can also include electronic information from the target such as online information 204 associated.

With bank accounts, loans, credit facilities and the like. Data sources can also include third party physical information 206 such as financial documents, contracts, insurance policies, and the like. The system can be in electronic communications with third party systems such as banks, financial institutions, credit providers, governmental agencies, third party data providers, and the like so that information can be received by the system without document processing. Data sources can also include third party electronic information 208 such as tax rates, cost of living indexes, educational costs, and the like. The information and data can be stored in the target database or stored in external database accordingly. The data can be associated with the target as well as with an associated target such as a relative or affiliate of the target.

Referring to FIG. 2B, the recommendation engine 118 can include a machine learning unit 226 that can be included in the recommendation engine or can be accessible by the recommendation engine. The machine learning unit can receive initial input 228 from individuals with experience in each subject matter area to creates an initial ruleset 230 which can include sub-rulesets 230 for each subject matter. The rules can include an attribute for a target for each subject matter and a recommended action or inaction including a deadline. The initial ruleset can also include a timeline or deadline associated with the action as well as a priority status (e.g., low, medium, high), and whether the action should be automated or manual. As the system receives targets, the target database is updated, and the recommendation engine provides new recommendations 232 to each new target. As the financial professional indicates if and when an action is taken or to be taken at 234, this recommendation compliance information is provided to the machine learning unit. The machine learning unit can determine if the existing ruleset concerning the associated recommendation and action, sufficiently deviate from the information gathered from the financial professional and modify the ruleset accordingly.

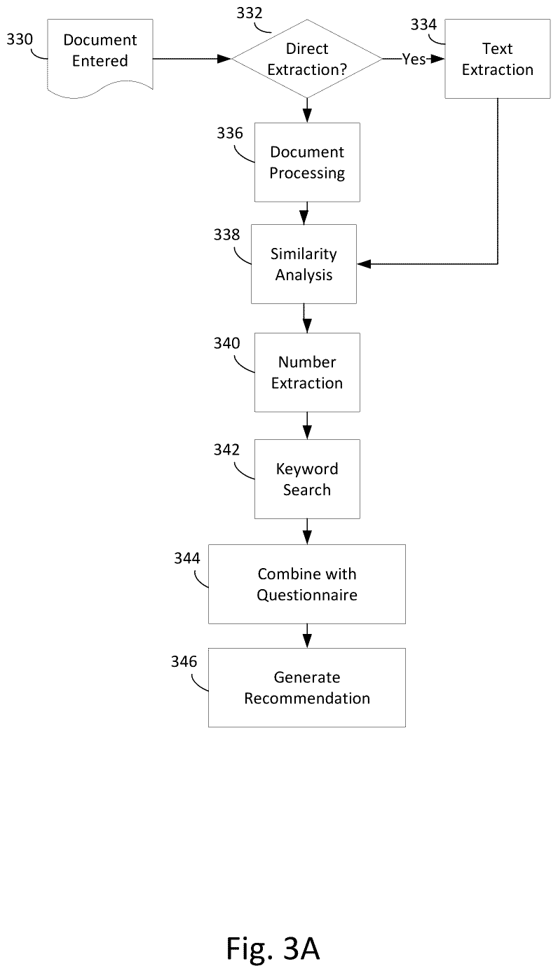

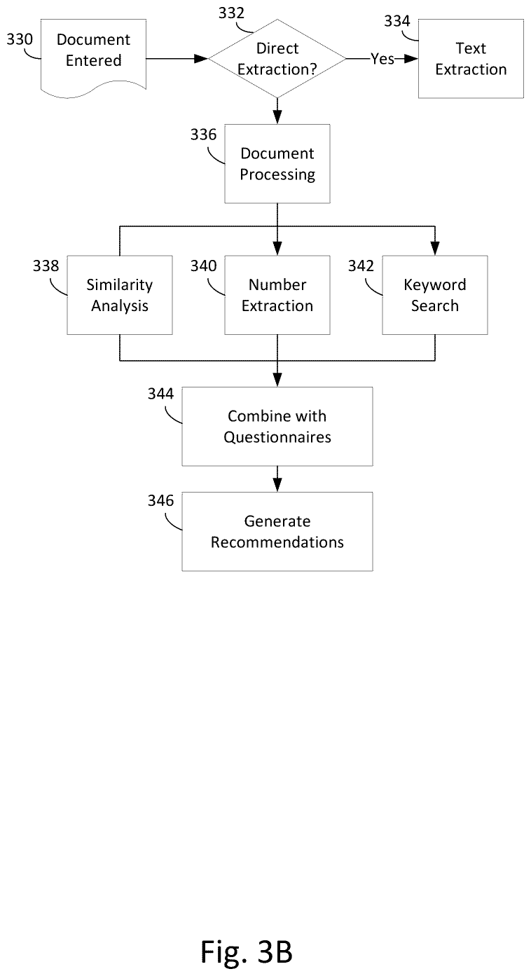

Referring to FIG. 3A, data or information from a physical data source such as a document 330 can be entered into the system. A determination at 332 is made whether the data can be extracted directly from the document or if further processing (e.g., OCR) is needed. Through prior review and learning of the various forms and types of documents involved in financial, estate, insurance and/or risk planning, such as tax returns, mortgages, bank statements, debt statements, loan documents, a tax returns, retirement statements, insurance policies, wills, trusts, financial plans, investment statements and a debt-to-income ratio analysis, the system is capable of identifying what type of document is being entered into the system. Once the system identifies the document type, it may identify the relevant and/or important pages or sections of the document from which data needs to be extracted. For example, if a target uploads a tax return, the system will first identify the document as being a tax return and will then begin looking for sections of interest such as the form 1040. Once the system has identified the appropriate pages and/or sections, it will identify the appropriate data that needs to be extracted. For example, the system may identify certain line items within the form 1040 as containing relevant and/or important information that is required to capture the target's financial situational information. Next, the system will extract the relevant data and/or values and store that information in association with the appropriate subject matter (e.g., income, deductions, age, premium, etc.).

If the relevant section, form, or information for which the system is searching is missing and/or unable to be scanned, the system will notify the user that such information could not be obtained. Such notification could be a dialog box or the entry of a value of zero associated with the subject matter.

The system can extract data from scanned and poorly visible documents. If data can be directly extracted, it is extracted at 33. Otherwise, the document can be processed such as with OCR or other means at 336. The system can store the extracted data in raw text and/or as a graphic file (e.g., screen shot) so that data can be subsequently reviewed with an indication of potential issues or can be extracted directly from the document and placed in a database. For example, if the data extracted from line 7 of a tax form is supposed to be equal to the addition of lines 5 and 6 but as extracted is not so equal, the system can alert the user of the discrepancy and display the raw text and/or graphic file so that the user can ensure that the numbers and/or data values were properly uploaded (e.g., to ensure that a value of $100.00 was not extracted as $10000).

The data extracted from the document can then be processed using similarity analysis at 338. Similarity analysis is the process of identifying concepts within the document to determine if certain concepts are present in the document by determining if it has the same or similar words or data. This process allows the discovery of conditions, clauses, terms, and other information and data in the document that either directly exists or can be determined to exist from words or sentences that could have the same meaning. A simplistic example includes the determination if an insurance policy covers a secondary driver. In this example, the similarity analysis could discover the term “alternate driver”, equate this to secondary driver and determine that the policy does include coverage for a secondary driver and consider this when determining risk and making recommendations to the financial advisor.

This text similarity task also allows risks to be mitigated when the language of legal documents is compared to an existing document that has been proved to be resilient (e.g., tested in court, approved by a third party, or otherwise verified) so that the risk of the new document contract being the cause of loss is minimized. As the number of documents analyzed grows, automatic linking of related documents allows the ability to analyze similar or identical situations and for them to be treated similarly.

Number extraction can also be performed on the data at 340. Number extraction is a process where numbers are extracted based on the proximity the number is in the text to a known concept (e.g., insurance premium) and/or placement within a form (e.g., line-item placement). For example, we can look for numbers in the raw text and when we find a number that is the closest in proximity to the terms in the document that represent “total premium” we then can identify that the proper number has been extracted. Numbers can be further processed to remove characters such as “$” and “,” so that calculations can be performed. Once these characters are removed, we can convert to a numeric format so that calculations can be performed. As mentioned before, the system may also retain raw text, raw data and/or a graphic file of the numbers being extracted so that where necessary or advisable, the user may view the text, data, or graphic file to ensure that the numbers were properly extracted. Once extracted, the number values may be stored in association with the subject with which the number is associated (e.g., income, asset value, account balance, etc.).

In one embodiment, the similarity analysis, number extraction and key word search are performed simultaneously as shown in FIG. 3B. Once data extraction is completed, the extracted data can be compared and/or combined with the answers to questionnaires at 344 (and other sources as described herein). Data can originate or be obtained from bank accounts, credit cards, investment accounts, mortgage portals, student loan portals and home values (e.g., as expressed through sites such as Zillow, Trulia, Redfin, Homesnap, Neighborsnap and the like) and client relationship manager (CRM) systems. A CRM can be internal and associated with the user financial professional or can be from a third party that allows access to the data. For example, a target may instruct the target's accountant to grant access to the CRM information of the accountant for use by the system. This may allow the system to retrieve tax and other financial information to be retrieved by the system without the increased cost of the accountant gathering the information and transmitting it to the financial professional and financial professional having to enter the information into the system manually. With the data, the recommendation engine can provide recommendations that can be made at 346 and can include actions to take and deadlines for when the action is recommended to be taken.

The data can also be extracted with keyword searching at 342. Keyword searching is the process of using a predetermined set of works, terms or phrases that are simple to find in documents and can be common. This process scans the documents and looks for keywords in the data. Recommendations can be associated with the predetermined keywords so that when the keyword is discovered, the recommendation can be presented to the financial advisor.

For example, when an estate document such as a will is uploaded, the system may extract all the text of the will and it will begin conducting searches for terms commonly used in a will such as executor, guardian, sibling, dependent, conservator, etc. As an initial matter, the system will identify the assets that are to be distributed by the will. The system may then search for the names of the people identified in the will and associate them with the position assigned to them by the will (e.g., John Smith=Executor). The system is also capable of recognizing that John Smith may be referred to under pseudonyms such as J. Smith, John, or Mr. Smith. The system will link John Smith and all associated pseudonyms with Executor. Once the system has associated everyone named in the will with their respective position (sibling, beneficiary, executor, conservator, etc.), the system will search for triggering events that will prompt action to be taken on the assets (such as distribution). Once the triggering events have been identified, the system will search for and associate the rules for acting upon the assets that are associated with each of the identified triggering events. The system may then use this data to create a data tree, identifying the assets and parties identified in the will and showing how the assets will be acted upon in response to each of the triggering events contemplated by the will. The following example is illustrative only to show how key word searching may be completed by the system. This type of searching is not limited to estate related documents but could be conducted on any of the documents to obtain the target specific data, including the target's financial situational information.

Once all the relevant data, text and/or numbers are extracted from the document, the system may then delete the document to decrease the chance of unauthorized access to such documents.

Referring to FIG. 4A, the user screen 400 of the system has various sections that can represent modules including the current target 402, profile 404, dashboard 406, subject matters or areas 408, task manager 410, reports 412, questionnaire enter and review 414 and communications area 416. The modules can be for the system globally or can be filtered for a specific target. The task manager, in this example, is selected for an example target and provided to the user (e.g., financial advisor) with recommendations 418 directed to the target, suggested actions 420, the user 422 and a deadline 424. The recommendations are a product of the analysis of the gathered input from the disparate data sources, the natural language processing, the rolling feedback aspects of the system as provided by the recommendation engine. The priority in which the recommendations are displayed can be according to a ruleset in the various areas, from the ruleset representing the modifications to the ruleset or some combination.

In operation, data from the target is collected and associated with that target in a multitude of areas that include data collection, information, and recommendations for the areas of mortgage, tax planning, debt, disability insurance, auto insurance, identify theft protection, long term care, medical insurance, home insurance, investment planning, retirement planning, estate planning and others. The system can display the percentage of information and analysis that has been completed. The system can also provide indications of priority so that the user (e.g., financial planning professional) can determine which areas need more or less focus and/or which areas have a greater time sensitivity for action to be taken.

The system can use natural language process through a natural language processing engine that can include natural language computer readable instructions for determining the type of data that was entered into the system such as contracts, policies, legal documents, financial documents, and the like. The natural language engine can determine if the documents fall into categories such as wills, insurance policies, bank account records and statements, loan documents (e.g., mortgages), assets descriptions, and the like. The natural language engine can remove irrelevant characters, tokenize the text into individual words or phrases, remove irrelevant words (e.g., “@”, “.com”, www.), convert all characters to a common case, combine misspelled words, lemmatization terms, (e.g., reduce words such as “am”, “are”, and “is” to a common form such as “be”) and error checking. The natural language engine can then take the remaining words and convert the text to numerical values, recognize patterns in the values, and build a vocabulary of unique words so that each sentence is represented by a listing of values. The values can be processed to determine the occurrence of any word and to determine what category the document best fits (e.g., insurance policy, mortgage, etc.). The natural engine can also determine the rarity of certain words to assist with the categorization and extraction of data from the document. For example, a mortgage would have a higher frequency of the term property than a life insurance policy. As the natural language engine analyzing documents and the results are placed on the system when the financial professional determines the category of the document, the natural language engine rules can be updated so that a similar document in the future will be classified the same as the document classification provided to the first document by the financial professional. Therefore, the natural language engine can learn from the change to the classification of documents made by the financial professional using the system.

Referring to FIG. 4B, the recommendation that can be made within an area 426 (e.g., revocable trust) is shown in more detail. The recommendations are provided from the recommendation engine according to the gathered input from the disparate data sources, the natural language processing, and the rolling feedback aspects of the system. In the example shown, the first recommendation 428 is directed to assets that have been moved into trust.

Referring to FIG. 4C, within each area of the user screen 400, there can be subareas 430 for further refinement of the selected area or subject matter. For example, for the area of estate planning, there can be the subareas or categories 426 that can include general, updates, fiduciaries, wills, trusts, powers of attorney, estate tax, Medicare, life insurance, gifts, goals of the target and recode and document management. In these areas, recommendations can be generated that can be used to assist the target as well as to modify the ruleset. The recommendation engine can recommend an action for several items within each area or subarea. Given the number of areas and subareas, there can be multiple feedback loops which can each be tailored for the specific area or subarea.

When collecting data, there are several methods for the data to be received by the system which can be subject matter specific. For example, areas of data that can be received include general information, estate planning, auto insurance, disability insurance, home insurance, medical insurance, identify theft information, student debt, tax planning and long-term care. Information can be received in the form of a questionnaire or can be retrieved from other sources. This data can be in the form of text (e.g., Word documents) or readable documents (e.g., PDF) or other formats (TIFF) allowing the document to be read but not necessarily allowing data to be directly extracted.

The recommendation engine can include computer readable instructions that provide for data extraction and analysis performed on the data which are the associated with the target. When new data representing a new or prospective target is extracted, the new data is stored in a vector that can be compared to the historical data of existing targets. A cosine similarity analysis can be used to compare the new data with the historical data. This analysis determines the cosine of the angle between new data vector and the historical data vector and projects the results in a multi-dimensional space. The results of this analysis are a set of recommendations that existing targets having similar parameters have taken to improve their financial wellbeing. The results are presented as recommendations and suggestions to the financial advisor that can then be discussed with the new or prospective target.

This system can measure the similarity between two non-zero vectors (e.g., the new data and the historical data) of the inner product space and determines the cosine of the angle between these two vectors. The cos θ° is 1 and <1 for any angle in the interval (0, π] radians. The cosine similarity allows a determination of the orientation (not magnitude) of the two vectors. Using cosine similarity, the information retrieved in the data extraction and historical data can be assigned a different dimension. The results of the analysis can be characterized by a vector where the value in each dimension corresponds to the number of times the term appears in the document or data. Cosine similarity allows the determination of how similar two documents are concerning their subject matter. The function of the analysis can be represented as:

$$similarity = cos ( θ ) = \frac{A \times B}{‖ A ‖ ‖ B ‖} = \frac{{\sum }_{i = 1}^{n} {A}_{i} {B}_{i}}{\sqrt{{\sum }_{i = 1}^{n} {A}_{i}^{2}} {\sqrt{{\sum }_{i = 1}^{n} {B}_{i}^{2}}}^{2}} \qquad ( 1 )$$

where Aᵢ and Bᵢ are components of the vector A and B respectively.

The system can include computer readable instructions for comparing existing data with historical data such as Pearson's product-moment correlation which can be illustrated by the following formula:

$$r = \frac{n ( \sum xy ) - ( \sum x ) ( \sum y )}{\overline{\sqrt{[ n \sum {x}^{2} - {( \sum x )}^{2} ] [ n \sum {y}^{2} - {( \sum y )}^{2} ]}}} \qquad ( 2 )$$

Spearman's correlation which can be illustrated, in one embodiment, by the following formula:

$$ρ = 1 - \frac{6 \sum {d}_{i}^{2}}{n ( {n}^{2} - 1 )} \qquad ( 3 )$$

Jaccard's Similarity (coefficient) which can be illustrated by the following formula:

$$J ( A , B ) = \frac{\vert A∩B \vert}{A ⋃ B} = \frac{\vert A∩B \vert}{\vert A \vert + \vert B \vert - \vert A∩B \vert} \qquad ( 4 )$$

Using one or more of these methods the system can determine the relevance between difference in a net target information, existing target information, information changes, changes input or any combination thereof. For example, a first-year tax return can be entered for a target. A second-year tax return can be entered for the target. Similarity analysis can be performed to determine the relevance of any differences between the two returns.

Further, the system can use similarity analysis to determine the similarity of a first data when compared to a second data. If a document is entered, the system can determine the similarity of the document and existing data in the system's database. The system can determine that the document is similar to a loan document and therefore that the information to be pulled from the document is associated with a loan. With this feature, the system can retrieve documents from third parties, receive documents in electronic form or have document scans entered and determine the information type and relevance of the document information.

When a new target is accepted, the profile of the target can be displayed to the user such as with a profile screen 432 shown in FIG. 4D. The user screen 400 can quickly display and represent the functionality of the system and can include vital statistics, goals, related targets or other individuals, and areas of analysis of the target with percentage of completeness. The profile can also display basic information of the target, editable by the user, and including age, address, occupation, net worth, etc. a screen area 434. Users can also add goals and contact information, as well as adding or removing areas of planning for the target.

The target can also have information displayed in a dashboard 436 as shown in FIG. 4E. When capturing data, a questionnaire can be used to capture data from the target using questionnaire screen 438 and questionnaire data requests 440 as shown in FIG. 4F, representing one data request for one topic of one subject matter.

By way of example the operation of the system can be shown by the process and steps described herein. This example is to provide those skilled in the art with one example of the description of the operation of this system and is not to be limited. In this example, the target or potential target can provide basic information about the target (birthday, address, etc.). Information about the target can be obtained from a survey, bank records, credit card records, investments accounts, mortgage providers, student loans providers, home value informational sources and the like. For example, the system can be in electronic communications with a student loan provider so that information about the student loan can be retrieved from the student loan provider into the system. The system can also create a list of documents to be requested from the target. When these documents are provided, information about the target can be gathered automatically. The information can be sent to an email account or other destination that can be received by the system automatically. The documents can be processed (e.g., data extraction) automatically by the system. Once the information is processed, recommendations can be generated and provided to the financial planner. The financial planner can then meet with the target and review any recommendations and actions. Based on whether the target takes or does not take an action. The system can update the target associated information to reflect the decision of the target. The learning engine uses the initial information, the actions, and the actions and information from other targets to provide the recommendation engine with the information needed to provide recommendations.

It is understood that the above descriptions and illustrations are intended to be illustrative and not restrictive. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

Further, embodiments within the scope of the present invention may also include computer-readable media for carrying or having computer readable or computer executable instructions or data tables, or data structures stored thereon. Such computer readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code in the form of computer executable instructions or data structures. When information is transferred or provided over a network or another communications connection (either hardwired, wireless, or combination thereof) to a computer, the computer properly views the connection as a computer readable medium. Thus, any such connection is properly termed a computer readable medium. Combinations of the above should also be included within the scope of the computer-readable media.

Computer readable instructions include, for example, instructions and data which cause a general computer, special purpose computer, or special purpose processing device to perform a certain function or group of functions. Computer readable instructions also include program modules that are executed by computers in stand-alone or network environments. Generally, program modules include routines, programs, objects, components, and data structures, etc. that perform particular tasks or implement particular abstract data types. Computer readable instructions, associated data structures, and program modules represent examples of the program codes for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Although the above description may contain specific details, they should not be construed as limiting the claims in any way. Other configurations of the described embodiments of the invention are part of the scope of this invention. For example, the order of acts in the exemplary process illustrated by flowcharts and schematics may be changed. Accordingly, the appended claims and their legal equivalents should only define the invention, rather than any specific examples given.

What is claimed is:

1. A dynamic computerized feedback system for decision making recommendations and risk mitigation comprising:
a computerized system having an input engine wherein the input engine is adapted to receive input taken from a group consisting of a mortgage document, a bank statement, a debt statement, a loan document, a tax return, a retirement statement, an insurance policy, a will, a trust, a financial plan and a debt-to-income ratio analysis and create a digital input representation representing a binary conversion of the input;
a similarity engine included in the computerized system adapted to receive the digital input representation, determine a document type according to a vector analysis and a database of document types and identify digital information from fields from the digital input representation for export from the digital input representation;
a database of recommendation information representing decisions of past participants provided by prior advisors for each digital input representations identified by the similarity engine;
a recommendation engine having a decision ruleset and adapted to receive an exported fields from the digital input representation, create a recommendation based upon the exported fields, a digital ruleset, and the database of recommendation information, receive a decision to implement a recommendation, and update the database of recommendation information according to a decision information; and,
display the recommendations on a display in communications with the computerized system.

2. The system of claim 1 wherein the computerized system is adapted to create an initial an action plan according to a comparison of a recommendations.

3. The system of claim 2 wherein the computerized system is adapted to create an initial action plan according to a personal financial goal of a target participant associated with the digital input representation.

4. The system of claim 1 wherein the digital ruleset is a learning model created using multiple individual experts in the fields of consisting of tax, insurance, accounting, personal finance, wealth management, estate planning and any combination thereof.

5. The system of claim 1 wherein the computer system is configured to digitally transmit the recommendation to a remote advisor computer system inaccessible to a target participant.

6. The system of claim 1 wherein the computer system is configured to receive a recommendation compliance representing that a recommendation was accepted and modify the database of recommendation information according to the recommendation compliance.

7. The system of claim 6 wherein the database of recommendation information is a first database of recommendation information, and the computerized system is configured to digitally modify a second database of recommendation information stored on a remote computer system according to the recommendation compliance.

8. The system of claim 1 wherein the database of recommendation information is created using a natural language engine having natural language computer readable instructions, receiving natural language, generating a translation model using context, reading natural language derived data from the natural language according to a translation model, and modifying the database of recommendation information.

9. The system of claim 1 wherein the computer system is adapted to retrieve additional information from a third-party electronic source wherein the third-party electronic source is taken from the group consisting of a financial computer system, a credit computer system, an investment computer system, a mortgage computer system, a student loan computer system, an insurance computer system, and any combination thereof.

10. A dynamic computerized feedback system for decision making, recommendations and risk mitigation comprising:
a computerized system having an input engine wherein the input engine is adapted to receive input and create a digital input representation representing a binary conversion of the input;
a similarity engine included in the computerized system adapted to receive the digital input representation, identify digital information from a document type and fields from the digital input representation for export from the digital input representation, export the identified fields into an analysis file;
a database of recommendation information representing decisions of past participants provided by prior advisors for each digital input representations identified by the similarity engine;
a recommendation engine having a decision ruleset and adapted to receive the analysis file from the digital input representation, create a recommendation based upon the analysis file, a digital ruleset, and the database of recommendation information, receive a decision to implement a recommendation, and update the database of recommendation information according to the decision information; and,
display the recommendations on a display in communications with the computerized system.

11. The system of claim 10 wherein the similarity engine is adapted to identify digital information from a document using vector analysis.

12. The system of claim 11 wherein the similarity engine is adapted to determine a difference between the digital input representation and a preexisting digital file wherein if the difference is under a predetermined threshold the digital input representation and a preexisting digital file are determined to be similar.

13. The system of claim 10 wherein displaying the recommendation on a display in communications with the computerized system include providing a dashboard.

14. The system of claim 10 wherein the recommendation engine is adapted to update the ruleset according to the decision information thereby providing a feedback loop according to decision information to provide a learning system through modification of the ruleset with decision information.

15. A dynamic computerized feedback system for decision making, recommendations and risk mitigation comprising:
a computerized system having an input engine wherein the input engine is adapted to receive input and create a digital input representation representing a binary conversion of the input;
a similarity engine included in the computerized system adapted to receive the digital input representation, identify digital information from a document type and fields from the digital input representation for export from the digital input representation, export the identifier fields into an analysis file;
a database of recommendation information representing decisions of past participants provided by prior advisors for each digital input representations identified by the similarity engine;
a recommendation engine having a decision ruleset and adapted to receive the analysis file from the digital input representation, create a recommendation based upon the analysis file, a digital ruleset, and the database of recommendation information, receive a decision to implement a recommendation, update the database of recommendation information according to the decision information and update the digital ruleset according to the decision information; and,
display the recommendations on a display in communications with the computerized system.

16. The system of claim 15 wherein the computerized system is a first computerized system and is adapted to transmit the updated database to a second computerized system in communications with the first computerized system to provide the second computerized system a benefit of the decision information.

17. The system of claim 15 wherein the computerized system is a first computerized system in communications with the first computerized system and is adapted to transmit the updated ruleset to a second computerized system.

18. The system of claim 15 wherein the recommendation engine is adapted to gather input from a disparate data source, a natural language processing system, and a rolling feedback aspect of the system to provide recommendations.

19. The system of claim 15 wherein the similarity engine is adapted to use term frequency in the digital input representation to determine an input type and fields to extract from the digital input representation.

20. The system of claim 15 wherein the similarity engine is adapted to use natural language processing to determine an input type and fields to extract from the digital input representation.
